(19) United States
(12) Patent Application Publication
(10) Pub. No.: US 2023/0289452 A1
(43) Pub. Date: Sep. 14, 2023

(54) METHOD AND APPARATUS FOR MANAGING TECHNICAL INFORMATION BASED ON ARTIFICIAL INTELLIGENCE

(71) Applicant: AGENCY FOR DEFENSE DEVELOPMENT, Daejeon (KR)

(72) Inventors: Justin Chanwook JANG, Daejeon (KR); Heesu KIM, Daejeon (KR)

(21) Appl. No.: 18/156,223

(22) Filed: Jan. 18, 2023

(30) Foreign Application Priority Data
Jan. 19, 2022 (KR) 10-2022-0007851

(51) Int. Cl. G06F 21/60

(52) U.S. Cl. CPC G06F 21/60

(57) ABSTRACT

A method and apparatus for managing technical information based on artificial intelligence is proposed. The method may use an apparatus which designs an outlier detection model based on data collected from at least one device provided in a specific area. The method may include generating a plurality of primary clusters by primarily clustering a dataset collected in the specific area based on first attribute information corresponding to a device through which data passes. The method may also include generating a plurality of secondary clusters to be subdivided by secondarily clustering data included in each cluster based on second attribute information. The method may further include generating a plurality of outlier detection models for the primary and secondary clusters. The method may further include determining non-clustered data for each secondary cluster as an outlier with a possibility of technology leakage using the outlier detection models for newly input data.

### CROSS-REFERENCE TO RELATED APPLICATION

This application claims priority to Korean Patent Application No. 10-2022-0007851 filed on Jan. 19, 2022. The entire contents of the application on which the priority is based are incorporated herein by reference.

### BACKGROUND

### Technical Field

The present disclosure relates to a method, system, and apparatus for managing technical information based on artificial intelligence for preventing technology leakage and, more particularly, to a method, system, and apparatus for managing technical information based on artificial intelligence, which can predict the possibility of technology leakage by designing an outlier detection model in consideration of several pieces of attribute information about data collected in a specific area, and determining whether new data has an outlier or not based on the designed outlier detection model.

### Description of Related Technology

As the technology of companies improves, the leakage of technology also increases.

Industrial technology is mainly leaked by resigned employees, subcontractors, new employees, unauthorized persons, and core personnel. These people may leak the industrial technology by copying documents, printing, taking screenshots, opening files, modifying files, requesting access, and approving access for core technologies such as advanced technology and production technology, or key documents such as contracts and test reports. As a result, there is an increase in the infringement of valuable corporate assets.

Although the country is also revising laws to prevent technology leakage, the technology leakage may not be prevented merely by the law revision. Therefore, companies need to implement their own technology management strategies rather than relying on the force of law.

So far, leakage is often perceived only after the industrial technology is leaked, and there is no proper system for predicting leakage.

### SUMMARY

Accordingly, the present disclosure has been made keeping in mind the above problems occurring in the related art, and an objective of the present disclosure is to provide a method, system, and apparatus for managing technical information based on artificial intelligence, which can predict the possibility of technology leakage by designing an outlier detection model in consideration of several pieces of attribute information about data collected in a specific area, and determining whether new data has an outlier or not based on the designed outlier detection model.

The objectives of the present disclosure are not limited to the above-mentioned objectives, and other objectives which are not mentioned will be clearly understood by those skilled in the art from the following description.

In accordance with an aspect of the present disclosure, there is provided a method for managing technical information based on artificial intelligence, using an apparatus which designs an outlier detection model based on data collected from at least one device provided in a specific area, the method comprising: generating a plurality of primary clusters by primarily clustering a dataset collected in the specific area based on first attribute information corresponding to a device through which data passes; generating a plurality of secondary clusters to be subdivided by secondarily clustering data included in each of the plurality of primary clusters based on second attribute information including function information executed in the device corresponding to each data; generating a plurality of outlier detection models for the plurality of primary clusters and the plurality of secondary clusters; and determining non-clustered data for each secondary cluster as an outlier with a possibility of technology leakage using the plurality of outlier detection models for newly input data.

According to various embodiments, in generating the plurality of primary clusters, the data which is passed through the device includes data transmitted, received, generated, changed, and stored by the device.

According to various embodiments, the method further comprises adding attribute information corresponding to a new added device to each of the first attribute information and the second attribute information, whenever the new device is added to the specific area.

According to various embodiments, determining the non-clustered data as the outlier with the possibility of technology leakage further comprises: matching the newly input data with one of the plurality of outlier detection models, based on values in a first attribute information field or a second attribute information field of the newly input data; determining whether the newly input data is classified into one of the plurality of secondary clusters through the matched outlier detection model; and determining the newly input data as an outlier, when the newly input data is not classified into any of the plurality of secondary clusters.

According to various embodiments, generating the plurality of outlier detection models comprises: training the plurality of outlier detection models so that the plurality of outlier detection models group the collected dataset into one of plurality of groups related with the primary clusters and the secondary clusters by performing the primary clustering and the secondary clustering based on the first attribute information or the second attribute information.

According to various embodiments, in generating the plurality of outlier detection models, each of the plurality of outlier detection models is generated by learning dataset included in the corresponding cluster among the collected dataset.

In accordance with other aspect of the present disclosure, there is provided a method for managing technical information based on artificial intelligence, using an apparatus which designs and executes an outlier detection model based on data collected from at least one device provided in a specific area, the method comprising: generating a plurality of clusters by clustering a dataset collected in the specific area based on attribute information; generating a plurality of outlier detection models corresponding to the plurality of clusters by learning each of the plurality of clusters; matching the new data with any one of the plurality of outlier detection models, based on an attribute information field of introduced new data; and determining whether there is an outlier with a possibility of technology leakage for the new data through the matched outlier detection model.

According to various embodiments, the attribute information comprises at least one among information on a device through which data passes, and executed function information of a corresponding device for the data.

In accordance with other aspect of the present disclosure, there is provided an apparatus for managing technical information based on artificial intelligence, the apparatus designing an outlier detection model based on data collected from at least one device provided in a specific area, the apparatus comprising: a primary cluster generating module configured to generate a plurality of primary clusters by primarily clustering a dataset collected in the specific area based on first attribute information corresponding to a device through which data passes; a secondary cluster generating module configured to generating a plurality of secondary clusters to be subdivided by secondarily cluster data included in each of the plurality of primary clusters based on second attribute information including function information executed in the device corresponding to each data; an outlier detection model generating module configured to generate a plurality of outlier detection models for the plurality of primary clusters and the plurality of secondary clusters; and an outlier detection model execution module configured to determine non-clustered data for each secondary cluster as an outlier with a possibility of technology leakage using the plurality of outlier detection models for newly input data.

According to various embodiments, the primary cluster generating module makes the device correspond to the first attribute information for clustering a data, when the data which is passed through the device includes data transmitted, generated, changed, and stored by the device.

According to various embodiments, the primary cluster generating module and the secondary cluster generating module add attribute information corresponding to a new added device to each of the first attribute information and the second attribute information, whenever the new device is added to the specific area.

According to various embodiments, the outlier detection model execution module matches the newly input data with one of the plurality of outlier detection models, based on values in a first attribute information field or a second attribute information field of the newly input data, and determines whether the newly input data is classified into one of the plurality of secondary clusters through the matched outlier detection model, and determines the newly input data as an outlier, when the newly input data is not classified into any of the plurality of secondary clusters.

According to various embodiments, the outlier detection model generating module trains the plurality of outlier detection models so that the plurality of outlier detection models group the collected dataset into one of plurality of groups related with the primary clusters and the secondary clusters by performing the primary clustering and the secondary clustering based on the first attribute information or the second attribute information.

According to various embodiments, the outlier detection model generating module generates each of the plurality of outlier detection models by learning dataset included in the corresponding cluster among the collected dataset.

According to various embodiments, the apparatus further comprises: a technology leakage prevention policy execution unit configured to determine one of a plurality of preset technology leakage prevention policies according to the determination of the outlier detection model execution module regarding whether the new data has an outlier or not, thus execute the determined policy for the new data.

In accordance with another aspect of the present disclosure, here is provided a non-transitory computer-readable recording medium for storing a computer program, wherein, when the computer program is executed by a processor, the processor comprises an instruction to perform a method performed by an apparatus which designs an outlier detection model based on data collected from at least one device provided in a specific area, the method comprising: generating a plurality of primary clusters by primarily clustering a dataset collected in the specific area based on first attribute information corresponding to a device through which data passes; generating a plurality of secondary clusters to be subdivided by secondarily clustering data included in each of the plurality of primary clusters based on second attribute information including function information executed in the device corresponding to each data; generating a plurality of outlier detection models for the plurality of primary clusters and the plurality of secondary clusters; and determining non-clustered data for each secondary cluster as an outlier with a possibility of technology leakage using the plurality of outlier detection models for newly input data.

According to various embodiments, in generating the plurality of primary clusters, the data which is passed through the device includes data transmitted, received, generated, changed, and stored by the device.

According to various embodiments, the non-transitory computer-readable recording medium further comprises: adding attribute information corresponding to a new added device to each of the first attribute information and the second attribute information, whenever the new device is added to the specific area.

According to various embodiments, determining the non-clustered data as the outlier with the possibility of technology leakage further comprises: matching the newly input data with one of the plurality of outlier detection models, based on values in a first attribute information field or a second attribute information field of the newly input data; determining whether the newly input data is classified into one of the plurality of secondary clusters through the matched outlier detection model; and determining the newly input data as an outlier, when the newly input data is not classified into any of the plurality of secondary clusters.

According to various embodiments, generating the plurality of outlier detection models comprises: training the plurality of outlier detection models so that the plurality of outlier detection models group the collected dataset into one of plurality of groups related with the primary clusters and the secondary clusters by performing the primary clustering and the secondary clustering based on the first attribute information or the second attribute information.

In a method for managing technical information based on artificial intelligence according to an embodiment of the present disclosure, an outlier detection model is generated by clustering data of devices having similar data characteristics, so that detection performance can be improved compared to an outlier detection model generated by integrating data of all the devices.

In addition, technology leakage methods are becoming more diverse and complex. However, according to an embodiment of the present disclosure, even if an answer to the technology leakage detection is not individually provided by performing the outlier detection model with unsupervised learning, it is possible to increase the efficiency of technology leakage prevention by allowing an artificial intelligence model to expand on its own through a method of identifying attribute information related to constantly introduced data and classifying similar cases.

Effects of the present disclosure are not limited to the above-mentioned effects, and other effects which are not mentioned will be clearly understood by those skilled in the art from the following description.

### BRIEF DESCRIPTION OF THE DRAWINGS

FIG. 1 is a block diagram schematically showing the configuration of a technical information leakage prevention system based on artificial intelligence according to an embodiment of the present disclosure.

FIG. 2 is a block diagram schematically showing the configuration of a technical information management apparatus according to an embodiment of the present disclosure.

FIG. 3 is a conceptual diagram showing an example of device-based clustering according to an embodiment of the present disclosure.

FIG. 4 is a block diagram showing the configuration of an outlier detection model designing device according to an embodiment of the present disclosure.

FIG. 5 is a conceptual diagram showing an example of clustering according to an embodiment of the present disclosure.

FIG. 6 is a conceptual diagram showing an execution example of an outlier detection model generating module according to an embodiment of the present disclosure.

FIG. 7 is a flowchart illustrating a method for managing technical information based on artificial intelligence according to an embodiment of the present disclosure.

FIG. 8 is a flowchart illustrating an outlier detection model generating method for each cluster based on artificial intelligence according to an embodiment of the present disclosure.

FIG. 9 is a flowchart illustrating a method for generating an outlier detection model when a device is added according to an embodiment of the present disclosure.

### DETAILED DESCRIPTION

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

Hereinafter, embodiments of the present disclosure will be described in detail with reference to the accompanying drawings.

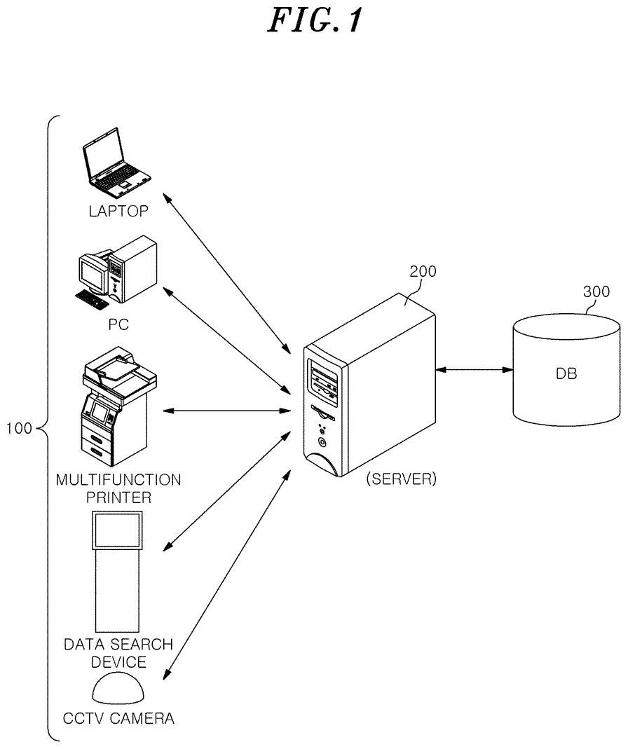

FIG. 1 is a block diagram schematically showing the configuration of a technical information leakage prevention system based on artificial intelligence according to an embodiment of the present disclosure.

Referring to FIG. 1, the technical information leakage prevention system 10 based on the artificial intelligence according to an embodiment of the present disclosure includes a device 100, a technical information management apparatus 200, and a database 300.

The device 100 may be at least one device which is installed in a specific area to transmit and receive information.

In an embodiment of the present disclosure, the specific area may be a communication network of the same domain range, for example, a range including hosts connected to the same medium using a shared medium such as Ethernet.

The device 100 is a device provided in the specific area, and may include, for example, a PC 110, a multifunction printer 120, a data search device 130, a CCTV 140, an electronic payment module 150, etc. The present disclosure is not limited thereto, but any device may be employed as long as it may be installed in the specific area and may transmit and receive information.

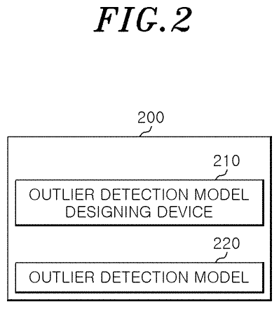

As shown in FIG. 2, the technical information management apparatus 200 includes an artificial intelligence outlier detection model designing device 210 which designs an artificial intelligence outlier detection model based on device attribute information related to data collected in the specific area, and an artificial intelligence outlier detection model 220 which determines whether new data has an outlier or not through an artificial intelligence outlier detection model for the new data which has been introduced. Here, the presence of the outlier means the possibility of leakage of technology related to the corresponding data, and may be referred to as whether there is an outlier in an outlier detection model.

To be more specific, the artificial intelligence outlier detection model designing device 210 first collects a dataset corresponding to at least one device in the specific area, and classifies the collected dataset into a plurality of clusters according to at least one of a corresponding device and information on the executed function of the corresponding device.

Further, the outlier detection model designing device 210 generates a plurality of outlier detection models which determine non-clustered data as outliers with a possibility of technology leakage for each classified cluster, and learns the plurality of outlier detection models.

Here, the dataset means data collected by each device provided in the specific area, and may refer to, e.g., data transmitted, received, generated, changed, and stored by each device, i.e., data passed through each device.

In an embodiment, the dataset may include a dataset corresponding to each device, such as a PC dataset, a multifunction printer dataset, a CCTV dataset, a data search device dataset, an electronic payment module based dataset, or an USB dataset.

Further, the dataset may be provided with a field corresponding to each device name. For example, the PC dataset includes a PC field, the multifunction printer dataset includes a multifunction printer field, the CCTV dataset includes a CCTV field, the data search device dataset includes a data search device field, and the electronic payment module dataset includes an electronic payment field.

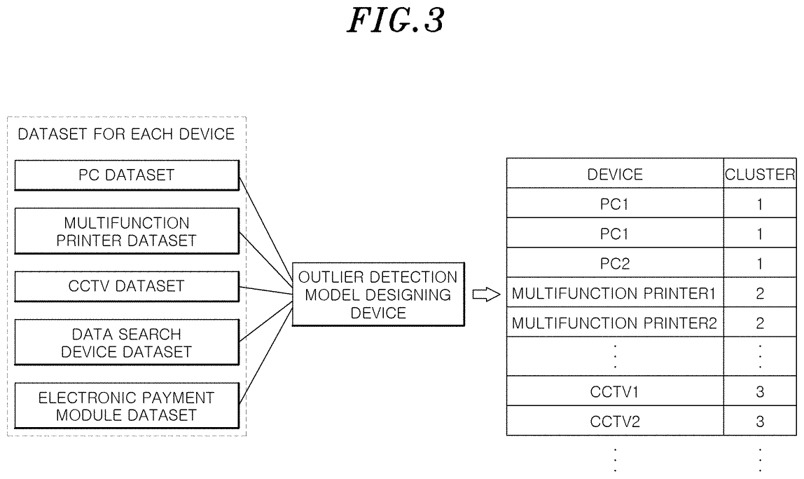

In an embodiment shown in FIG. 3, the datasets of a first PC, a second PC, and an Nth PC (N is a natural number) are clustered into cluster 1, and detection model 1 is generated through learning using the dataset included in cluster 1.

Further, the datasets of a first multifunction printer, a second multifunction printer, and an Oth multifunction printer (O is a natural number) are clustered into cluster 2, and detection model 2 is generated through learning using the dataset included in cluster 2.

Further, the datasets of a first CCTV, a second CCTV, and a Qth CCTV (Q is a natural number) are clustered into cluster 3, and detection model 3 is generated through learning using the dataset included in cluster 3.

Further, the datasets of a first data search device, a second data search device, and a Pth data search device (P is a natural number) are clustered into cluster 4, and detection model 4 is generated through learning using the dataset included in cluster 4.

Further, the datasets of a first electronic payment module, a second electronic payment module, and an Rth electronic payment module (R is a natural number) are clustered into cluster 5, and detection model 5 is generated through learning using the dataset included in cluster 5.

In this way, a number of detection models corresponding to the number of clusters may be generated.

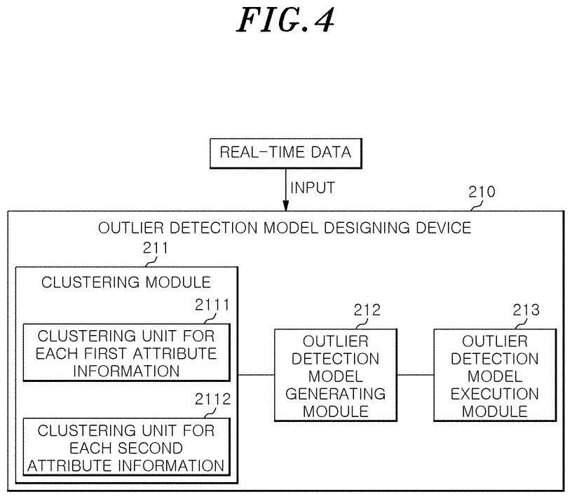

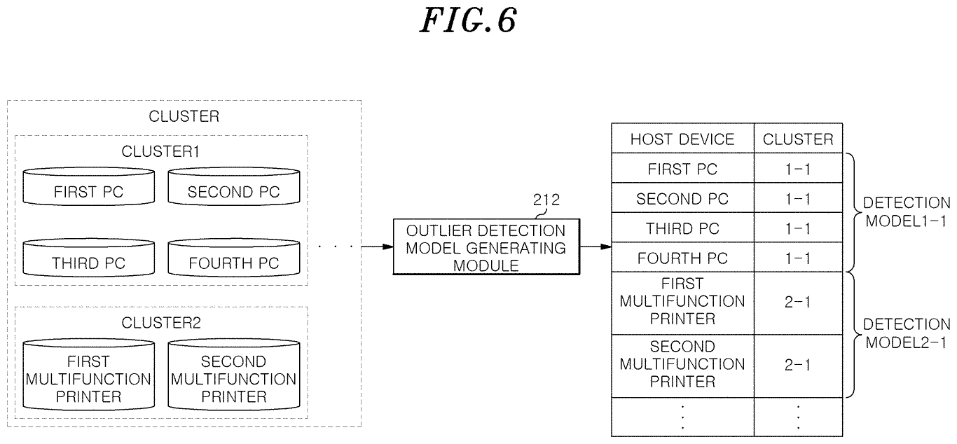

Referring to FIGS. 4 and 6, the outlier detection model designing device 210 performs clustering again on data included in each of the plurality of clusters based on second attribute information.

Since the second attribute information includes function information executed in the device, it may be a concept subordinate to the first attribute information including the device.

In the process of performing clustering again, the data included in the cluster may be classified in more detail.

In an embodiment, cluster 1 includes the first PC dataset, the second PC dataset, and the Nth PC dataset, and clustering is performed by subdividing the dataset for each first attribute information into the dataset for each second attribute information.

In an embodiment, each of the N PC datasets collected from N PCs includes a dataset (or a second dataset) for each second attribute information, in which information collected in the PC is divided according to functions executed in the PC, for example, a wireless network usage information dataset, a mail information dataset, an external hard drive information dataset, a cloud service information dataset, a network packet information dataset, an access address information dataset, a software download information dataset such as a backdoor or a malicious code, and a messenger information dataset.

As another example, each of the N multifunction printer datasets collected from N multifunction printers includes a dataset for each second attribute information divided according to functions executed in the multifunction printer, for example, a fax information dataset, an output information dataset, a copy information dataset, and a scan information dataset.

As a further example, each of the N CCTV datasets collected from N CCTVs includes a dataset for each second attribute information divided according to functions executed in the CCTV, for example, an object detection information dataset, a motion detection information dataset, and a motion movement direction tracking information dataset.

To elaborate with reference to FIG. 6, as clustering is performed again for cluster 1, cluster 1 may be subdivided into secondary clusters of cluster 1-1, cluster 1-2, and cluster 1-3.

In other words, for cluster 1, the wireless network usage information dataset may be clustered into cluster 1-1, the mail information dataset may be clustered into cluster 1-2, the external hard drive information dataset may be clustered into cluster 1-3, the cloud service information dataset may be clustered into cluster 1-4, the network packet information dataset may be clustered into cluster 1-5, the access address information dataset may be clustered into cluster 1-6, the software download information dataset such as the backdoor or the malicious code may be clustered into cluster 1-7, and the messenger information dataset may be clustered into cluster 1-8.

Furthermore, for cluster 2, the fax information dataset may be clustered into cluster 2-1, the output information dataset may be clustered into cluster 2-2, the copy information dataset may be clustered into cluster 2-3, and the scan information dataset may be clustered into cluster 2-4. The dataset for each second attribute information divided according to functions included in the first multifunction printer may be clustered into the aforementioned clusters.

Furthermore, for cluster 3, the object detection information dataset may be clustered into cluster 3-1, the motion detection information dataset may be clustered into cluster 3-2, and the motion movement direction tracking information dataset may be clustered into cluster 3-3. The dataset for each second attribute information divided according to functions included in the first CCTV may be clustered into the aforementioned clusters.

The outlier detection model generating module 212 performs learning for each classified secondary cluster to generate a plurality of secondary outlier detection models corresponding to a plurality of secondary clusters, respectively. To be more specific, the plurality of secondary outlier detection models may learn the plurality of outlier detection models to group the collected dataset by performing the primary clustering and the secondary clustering based on the first attribute information or the second attribute information of the dataset collected in the specific area.

Thus, detection model 1-1 corresponding to cluster 1-1 may be generated, detection model 1-2 corresponding to cluster 1-2 may be generated, and detection model 1-3 corresponding to cluster 1-3 may be generated.

That is, the outlier detection model designing device 210 primarily classifies the dataset collected in the specific area by the primary clustering, and secondarily classifies the dataset for attribute information included in the dataset for the attribute information by secondarily clustering the dataset by a primarily classified group.

Thereby, the outlier detection model may be generated for each primary cluster and each secondary cluster. As a result, data corresponding to a plurality of functions for each device may be clustered and managed.

Further, since the outlier detection model is generated by clustering data of devices having similar data characteristics, detection performance can be improved compared to the outlier detection model generated by integrating data of all the devices.

In addition, technology leakage methods are becoming more diverse and complex. Thus, according to an embodiment of the present disclosure, even if an answer to the technology leakage detection is not individually provided by learning the outlier detection model with unsupervised learning, it is possible to increase the probability of technology leakage prevention by allowing the artificial intelligence model to expand on its own through the method of identifying attribute information related to constantly introduced data and classifying similar cases.

Referring to FIG. 4, in order to perform the aforementioned process, the outlier detection model designing device 210 includes a clustering module 211, an outlier detection model generating module 212, and an outlier detection model execution module 213.

Further, the outlier detection model designing device 210 may include a communication unit for transmitting and receiving information, a control unit for computing information, and a memory (or database) for storing information.

In terms of hardware, the controller may be implemented using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electrical units for performing functions.

Further, in terms of software, embodiments such as procedures and functions described herein may be implemented by separate software modules. Each of the software modules may perform one or more functions and operations described herein. A software code may be implemented by a software application written in any suitable programming language. The software code may be stored in the memory and executed by the control unit.

The communication unit may be implemented through at least one of a wired communication module, a wireless communication module, and a near field communication module. A wireless Internet module refers to a module for wireless Internet access, and may be built into or external to each device. Wireless Internet technologies may use WLAN (Wireless LAN) (Wi-Fi), Wibro (Wireless broadband), Wimax (World Interoperability for Microwave Access), HSDPA (High Speed Downlink Packet Access), LTE (long term evolution), LTE-A (Long Term Evolution-Advanced), etc.

The memory may include at least one type of storage medium among a flash memory type, a hard disk type, a multimedia card micro type, a card type memory (e.g. SD or XD memory, etc.), a RAM (random access memory), an SRAM (static random access memory), a ROM (read-only memory), an EEPROM (electrically erasable programmable read-only memory), a PROM (programmable read-only memory), a magnetic memory, a magnetic disk, and an optical disk.

Hereinafter, each component of the outlier detection model designing device 210 according to this embodiment will be described in detail with reference to FIG. 4. The outlier detection model designing device 210 includes a clustering module 211, an outlier detection model generating module 212, and an outlier detection model execution module 213.

The clustering module 211 clusters the dataset collected in the specific area based on the first attribute information to generate a plurality of primary clusters for classifying the dataset. To this end, the clustering module 211 includes a clustering unit 2111 for each first attribute information and a clustering unit 2112 for each second attribute information.

In an embodiment, K-Means Clustering, Mean-Shift Clustering, Density-Based Spatial Clustering of Applications with Noise (DBSCAN), Expectation-Maximization (EM) Clustering using Gaussian Mixture Models (GMM), Agglomerative Hierarchical Clustering, or the like may be used as the clustering method.

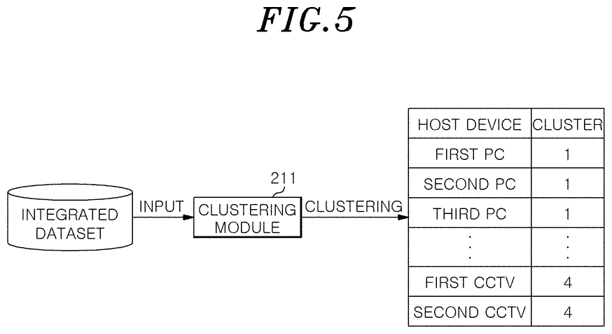

Referring to FIG. 5, an integrated dataset integrating the data collected in the specific area is primarily clustered by the clustering module 211. In the illustrated embodiment, the dataset corresponding to the first PC, second PC, and third PC is included as cluster 1, and the dataset corresponding to the first CCTV and second CCTV is included as cluster 4.

The clustering unit 2112 for each second attribute information may classify the dataset for each second attribute information by the cluster, and then perform secondary clustering for each cluster. In this connection, the designing model of the outlier detection model will be described below in detail.

The outlier detection model generating module 212 is primarily clustered in the clustering unit 2111 for each first attribute information to generate the outlier detection model for the generated cluster.

The outlier detection model generating module 212 performs learning using datasets for the first attribute information corresponding to a first PC, a second PC, a third PC, and a fourth PC included in cluster 1 to generate detection model 1. That is, the outlier detection model generating module 212 generates the corresponding outlier detection model for each cluster. The outlier detection model generating module 212 may perform learning using the dataset for each first attribute information corresponding to each device included in the cluster.

Further, the outlier detection model generating module 212 may generate a plurality of secondary outlier detection models corresponding to a plurality of secondary clusters generated by the secondary clustering performed for the primarily generated clusters. The second dataset included in the secondary cluster may be used to learn the secondary outlier detection model.

In an embodiment, the outlier detection model may perform unsupervised learning, without being limited thereto.

Technology leakage methods are becoming more diverse and complex. Thus, according to an embodiment of the present disclosure, even if an answer to the technology leakage detection is not individually provided by learning the outlier detection model with unsupervised learning, it is possible to increase the probability of technology leakage prevention by allowing the artificial intelligence model to expand on its own through the method of identifying attribute information related to constantly introduced data and classifying similar cases.

The outlier detection model execution module 213 matches a pre-learned outlier detection model using a first attribute information field or a second attribute information field of the newly input data, and then it is determined whether the newly input data is abnormal or normal using the matched outlier detection model. Here, for example, when it is determined that the outlier detection model execution result for new data is abnormal, it may be determined that there is a high possibility of technology leakage for the data. In contrast, when it is determined that the outlier detection model execution result for new data is normal, it may be determined that there is a low possibility of technology leakage for the data.

To be more specific, the outlier detection model execution module 213 may determine the similarity of device information (e.g., cosine similarity, Euclidean distance, and Manhattan distance) using each primary outlier detection model learned on the basis of the dataset after mapping a device characteristic value from newly input data to a vector space, and may select and map the primary outlier detection model having the highest similarity. At this time, when the similarity calculated by the outlier detection model execution module 213 does not satisfy a preset threshold, it may be determined that the execution result of the primary outlier detection model mapped above is abnormal and is data obtained via a new device. Here, when the outlier detection model generating module 212 determines that the new device is legally added, new attribute information may be added, a plurality of outlier detection models performing the primary clustering may be reconfigured or relearned, or a new outlier detection model may be generated. If the outlier detection model execution module 213 does not receive a response to the response request for the new device, it may be determined as an illegal device, and the newly input data is not classified into any secondary cluster. In this case, the newly input data may be determined as data with a high possibility of technology leakage.

The outlier detection model execution module 213 may match the second attribute information field of the newly input data with the secondary cluster, and match it with the secondary outlier detection model corresponding to the secondary cluster. For example, when the second attribute information field of the newly input data is mail information, the outlier detection model execution module 213 may be matched with the pre-learned secondary outlier detection model using the dataset of the mail information, and may determine whether the newly input data is classified into any one of the secondary clusters through the matched secondary outlier detection model. When the newly input data is not classified in any of the secondary clusters, the newly input data may be determined as an outlier.

To be more specific, when the outlier detection model execution module 213 determines that the execution result of the primary outlier detection model for the newly input data is normal, the secondary outlier detection model which performs the secondary clustering based on the similarity calculated by each secondary outlier detection model for function information (e.g., fax information, output information, and copy information) executed in the device corresponding to the data may be selected and mapped.

To be more specific, the outlier detection model execution module 213 may determine the similarity of function information (e.g., cosine similarity, Euclidean distance, and Manhattan distance) using each secondary outlier model learned on the basis of the dataset after mapping a characteristic value for function information executed in the device and corresponding to the newly input data to the vector space, and may select and map the secondary outlier detection model having the highest similarity.

At this time, when the similarity calculated by the outlier detection model execution module 213 does not satisfy a preset threshold, it may be determined that the execution result of the secondary outlier detection model mapped above is abnormal. Here, when the outlier detection model generating module 212 determines that the new function or the new function of the new device is legally added, new attribute information may be added. If the outlier detection model execution module 213 does not receive a response regarding the identification information and function information of the new device despite the request for a response to the new device, they may be determined as an illegal device and function, and the newly input data is not classified into any secondary cluster. In this case, the newly input data may be determined as data with a high possibility of technology leakage.

On the other hand, the management device 200 may further include a technology leakage prevention policy execution unit, which determines one of a plurality of preset technology leakage prevention policies according to the determination of the outlier detection model execution module 213 regarding whether the new data has an outlier or not, and executes the determined policy for the new data.

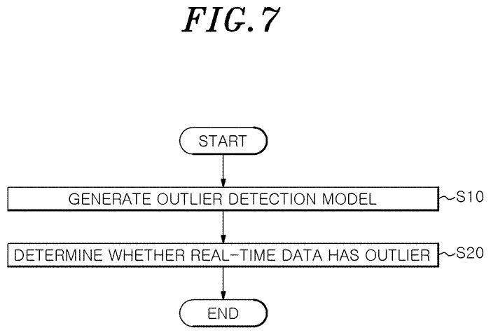

Hereinafter, a method for managing technical information based on artificial intelligence according to an embodiment of the present disclosure will be described with reference to FIGS. 7 to 9.

The method for managing the technical information based on the artificial intelligence according to this embodiment may be performed in substantially the same configuration as the management device 200 of FIG. 1. Therefore, components identical to those of the management device 200 of FIG. 1 are denoted by the same reference numerals, and repeated descriptions thereof are omitted.

Further, the method for managing the technical information based on the artificial intelligence according to this embodiment may be executed by software (application) for predicting and preventing the possibility of technology leakage using the artificial intelligence.

Referring to FIG. 7, the method 51 for managing the technical information based on the artificial intelligence according to an embodiment of the present disclosure includes a step S10 of generating the outlier detection model, and a step S20 of determining whether there is an outlier that has the possibility of technology leakage of new data through the outlier detection model.

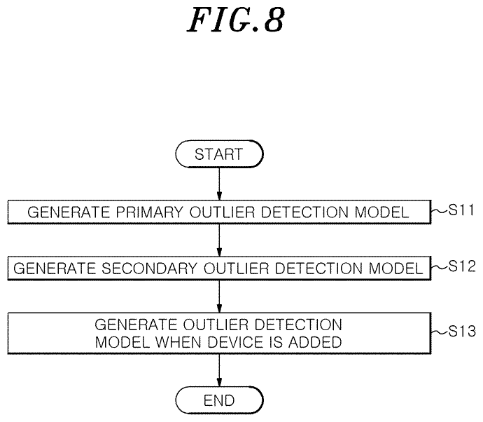

Referring to FIG. 8, the step S10 of generating the outlier detection model includes a step S11 of generating the primary outlier detection model, a step S12 of generating the secondary outlier detection model, and a step S12 of reconfiguring the outlier detection model when the device is added to the specific area.

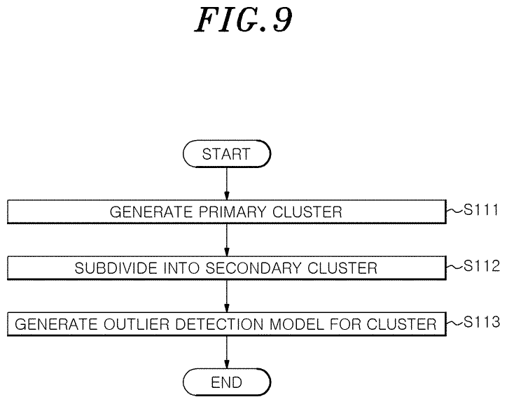

The method of generating the outlier detection model will be described in detail with reference to FIG. 9. In step S111, a plurality of primary clusters may be generated by clustering the dataset collected in the specific area based on first attribute information related to the device through which data passes. Here, in order to generate the primary clusters, each device may be classified for a device through which corresponding data passes (is processed) using the first attribute information of the dataset. For example, when the corresponding data is passed through (or processed) by at least one method among transmission, reception, generation, change, and storage in the corresponding device, the corresponding device may correspond to the first attribute information for the cluster of the data.

In the next step S112, clustering is performed again on the data included in each of the plurality of primary clusters based on the second attribute information including function information executed in the device corresponding to each data to be subdivided into secondary clusters.

In the next step S113, a plurality of outlier detection models may be generated, and the plurality of outlier detection models may be learned to determine non-clustered data for each secondary cluster as an outlier with a possibility of technology leakage.

Meanwhile, whenever a new device is provided in the specific area, attribute information corresponding to the new device may be added to each of the first attribute information and the second attribute information, and thus the outlier detection model may be reconfigured or relearned.

Next, after step S113, the method may further include a step of matching the new data with any one of the plurality of outlier detection models based on the first attribute information field or the second attribute information field of the introduced new data, and a step of determining whether the new data has an outlier through the matched outlier detection model.

Here, for example, when it is determined that the outlier detection model execution result for new data is abnormal, it may be determined that there is a high possibility of technology leakage for the data. In contrast, when it is determined that the analysis result for new data is normal, it may be determined that there is a low possibility of technology leakage for the data.

On the other hand, the method may further include a step of determining one of a plurality of preset technology leakage prevention policies according to the determination about whether the new data has an outlier or not by the execution of the outlier detection model, thus executing the determined policy for the new data.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for managing technical information based on artificial intelligence, using an apparatus which designs an outlier detection model based on data collected from at least one device provided in a specific area, the method comprising:
generating a plurality of primary clusters by primarily clustering a dataset collected in the specific area based on first attribute information corresponding to a device through which data passes;
generating a plurality of secondary clusters to be subdivided by secondarily clustering data included in each of the plurality of primary clusters based on second attribute information including function information executed in the device corresponding to each data;
generating a plurality of outlier detection models for the plurality of primary clusters and the plurality of secondary clusters; and
determining non-clustered data for each secondary cluster as an outlier with a possibility of technology leakage using the plurality of outlier detection models for newly input data.

2. The method of claim 1, wherein, in generating the plurality of primary clusters, the data which is passed through the device includes data transmitted, received, generated, changed, and stored by the device.

3. The method of claim 2, further comprising:
adding attribute information corresponding to a new added device to each of the first attribute information and the second attribute information, whenever the new device is added to the specific area.

4. The method of claim 1, wherein determining the non-clustered data as the outlier with the possibility of technology leakage further comprises:
matching the newly input data with one of the plurality of outlier detection models, based on values in a first attribute information field or a second attribute information field of the newly input data;
determining whether the newly input data is classified into one of the plurality of secondary clusters through the matched outlier detection model; and
determining the newly input data as an outlier, when the newly input data is not classified into any of the plurality of secondary clusters.

5. The method of claim 1, wherein generating the plurality of outlier detection models comprises:
training the plurality of outlier detection models so that the plurality of outlier detection models group the collected dataset into one of plurality of groups related with the primary clusters and the secondary clusters by performing the primary clustering and the secondary clustering based on the first attribute information or the second attribute information.

6. The method of claim 5, wherein, in generating the plurality of outlier detection models, each of the plurality of outlier detection models is generated by learning dataset included in the corresponding cluster among the collected dataset.

7. A method for managing technical information based on artificial intelligence, using an apparatus which designs and executes an outlier detection model based on data collected from at least one device provided in a specific area, the method comprising:
generating a plurality of clusters by clustering a dataset collected in the specific area based on attribute information;
generating a plurality of outlier detection models corresponding to the plurality of clusters by learning each of the plurality of clusters;
matching the new data with any one of the plurality of outlier detection models, based on an attribute information field of introduced new data; and
determining whether there is an outlier with a possibility of technology leakage for the new data through the matched outlier detection model.

8. The method of claim 7, wherein the attribute information comprises at least one among information on a device through which data passes, and executed function information of a corresponding device for the data.

9. An apparatus for managing technical information based on artificial intelligence, the apparatus designing an outlier detection model based on data collected from at least one device provided in a specific area, the apparatus comprising:
a primary cluster generating module configured to generate a plurality of primary clusters by primarily clustering a dataset collected in the specific area based on first attribute information corresponding to a device through which data passes;
a secondary cluster generating module configured to generating a plurality of secondary clusters to be subdivided by secondarily cluster data included in each of the plurality of primary clusters based on second attribute information including function information executed in the device corresponding to each data;
an outlier detection model generating module configured to generate a plurality of outlier detection models for the plurality of primary clusters and the plurality of secondary clusters; and
an outlier detection model execution module configured to determine non-clustered data for each secondary cluster as an outlier with a possibility of technology leakage using the plurality of outlier detection models for newly input data.

10. The apparatus of claim 9, wherein the primary cluster generating module is configured to make the device correspond to the first attribute information for clustering a data, when the data which is passed through the device includes data transmitted, generated, changed, and stored by the device.

11. The apparatus of claim 10, wherein the primary cluster generating module and the secondary cluster generating module are configured to add attribute information corresponding to a new added device to each of the first attribute information and the second attribute information, whenever the new device is added to the specific area.

12. The apparatus of claim 9, wherein the outlier detection model execution module matches the newly input data with one of the plurality of outlier detection models, based on values in a first attribute information field or a second attribute information field of the newly input data, and determines whether the newly input data is classified into one of the plurality of secondary clusters through the matched outlier detection model, and determines the newly input data as an outlier, when the newly input data is not classified into any of the plurality of secondary clusters.

13. The apparatus of claim 9, wherein, wherein the outlier detection model generating module trains the plurality of outlier detection models so that the plurality of outlier detection models group the collected dataset into one of plurality of groups related with the primary clusters and the secondary clusters by performing the primary clustering and the secondary clustering based on the first attribute information or the second attribute information.

14. The apparatus of claim 13, wherein the outlier detection model generating module generates each of the plurality of outlier detection models by learning dataset included in the corresponding cluster among the collected dataset.

15. The apparatus of claim 9, further comprising:
a technology leakage prevention policy execution unit configured to determine one of a plurality of preset technology leakage prevention policies according to the determination of the outlier detection model execution module regarding whether the new data has an outlier or not, thus execute the determined policy for the new data.
